(19) United States
(12) Patent Application Publication
(10) Pub. No.: US 2021/0283577 A1
(43) Pub. Date: Sep. 16, 2021

(54) WATER ABSORPTION TREATMENT MATERIAL AND METHOD FOR MANUFACTURING THE SAME

(71) Applicant: DAIKI CO., LTD., Tokyo (JP)

(72) Inventor: Junji YOSHINAGA, Tokyo (JP)

(73) Assignee: DAIKI CO., LTD., Tokyo (JP)

(21) Appl. No.: 17/334,586

(22) Filed: May 28, 2021

Related U.S. Application Data
(63) Continuation of application No. PCT/JP2019/045169, filed on Nov. 19, 2019.

(30) Foreign Application Priority Data
Jan. 23, 2019 (JP) 2019-008888

(51) Int. Cl. B01J 20/28; B01J 20/32; B01J 20/22; C02F 11/147

(52) U.S. Cl. CPC B01J 20/28016; B01J 20/3293; C02F 2103/005; C02F 11/147; B01J 20/22

(57) ABSTRACT

A water absorption treatment material absorbs a liquid, and includes a grain. The grain has a water absorbing property. The grain is in an obliquely-cut columnar shape having a side surface, and first and second bottom surfaces.

### CROSS REFERENCE TO RELATED APPLICATION

This is a Continuation of International Application No. PCT/JP2019/045169 filed Nov. 19, 2019, which claims the benefit of Japanese Application No. 2019-008888 filed Jan. 23, 2019. The contents of these applications are hereby incorporated by reference in their entirety.

### TECHNICAL FIELD

The present invention relates to a water absorption treatment material that absorbs a liquid, and a method for manufacturing the same.

### BACKGROUND ART

A conventional water absorption treatment material is disclosed in, for example, Patent Document 1. The water absorption treatment material disclosed in Patent Document 1 is composed of grains that have a water absorbing property. The grains are in a columnar shape having a side surface and two bottom surfaces.

### CITATION LIST

### Patent Document

Patent Document 1: JP 2017-93314A

### SUMMARY OF INVENTION

### Technical Problem

In the water absorption treatment material described above, a liquid to be treated is absorbed inside the grains from the side surface and the bottom surfaces of the grains. However, the water absorption treatment material has room for improvement in terms of water absorption velocity.

### Solution to Problem

The present invention has been made in view of the above-described problem, and it is an object thereof to provide a water absorption treatment material that has excellent water absorption velocity, and a method for manufacturing the water absorption treatment material.

A water absorption treatment material according to the present invention is a water absorption treatment material that absorbs a liquid. The water absorption treatment material includes a grain that has a water absorbing property. The grain is in an obliquely-cut columnar shape having a side surface, and first and second bottom surfaces.

In the water absorption treatment material, the grain is in an obliquely-cut columnar shape. As used herein, the obliquely-cut columnar shape refers to a shape obtained by cutting one end or both ends of a column by an obliquely-intersecting plane (a plane that obliquely intersects with the central axis of the column). The area of the bottom surfaces of the obliquely-cut column is larger than the area of the bottom surfaces of the original column. By enlarging the area of the bottom surfaces in this way, it is possible to increase the surface area of the grain to improve water absorption velocity of the water absorption treatment material.

Also, a method for manufacturing a water absorption treatment material according to the present invention is a method for manufacturing a water absorption treatment material that absorbs a liquid. The method includes a grain forming step of forming a grain that has a water absorbing property. In the grain forming step, the grain that is in an obliquely-cut columnar shape having a side surface, and first and second bottom surfaces is formed.

In this manufacturing method, the grain is formed in an obliquely-cut columnar shape. The area of the bottom surfaces of the obliquely-cut column is larger than the area of the bottom surfaces of the original column. By enlarging the area of the bottom surfaces in this way, it is possible to increase the surface area of the grain to improve water absorption velocity of the manufactured water absorption treatment material.

### Advantageous Effects of Invention

According to the present invention, it is possible to implement a water absorption treatment material that has excellent water absorption velocity, and a method for manufacturing the water absorption treatment material.

### BRIEF DESCRIPTION OF DRAWINGS

FIG. 1 is a perspective view showing an embodiment of a water absorption treatment material according to the present invention.

FIG. 2 is a side view showing a grain 10 in FIG. 1 viewed from the left direction.

FIG. 3 is a cross-sectional view showing the grain 10 in FIG. 1.

FIG. 4 is another cross-sectional view showing the grain 10 in FIG. 1.

FIG. 5 is a diagram for illustrating an example of a method for forming a core portion 22.

FIG. 6 is a diagram for illustrating an effect of a water absorption treatment material 1.

FIG. 7 is a diagram for illustrating the effect of the water absorption treatment material 1.

FIG. 8 is a diagram for illustrating the effect of the water absorption treatment material 1.

FIG. 9 is a perspective view showing the grain 10 according to a modified example.

FIG. 10 is a cross-sectional view showing the grain 10 in FIG. 9.

FIG. 11 is a diagram for illustrating an example of a method for forming the grain 10 in FIG. 9.

### DESCRIPTION OF EMBODIMENTS

Hereinafter, an embodiment of the present invention will be described in detail with reference to the drawings. In the description of the drawings, the same elements are given the same reference numerals, and a redundant description will be omitted.

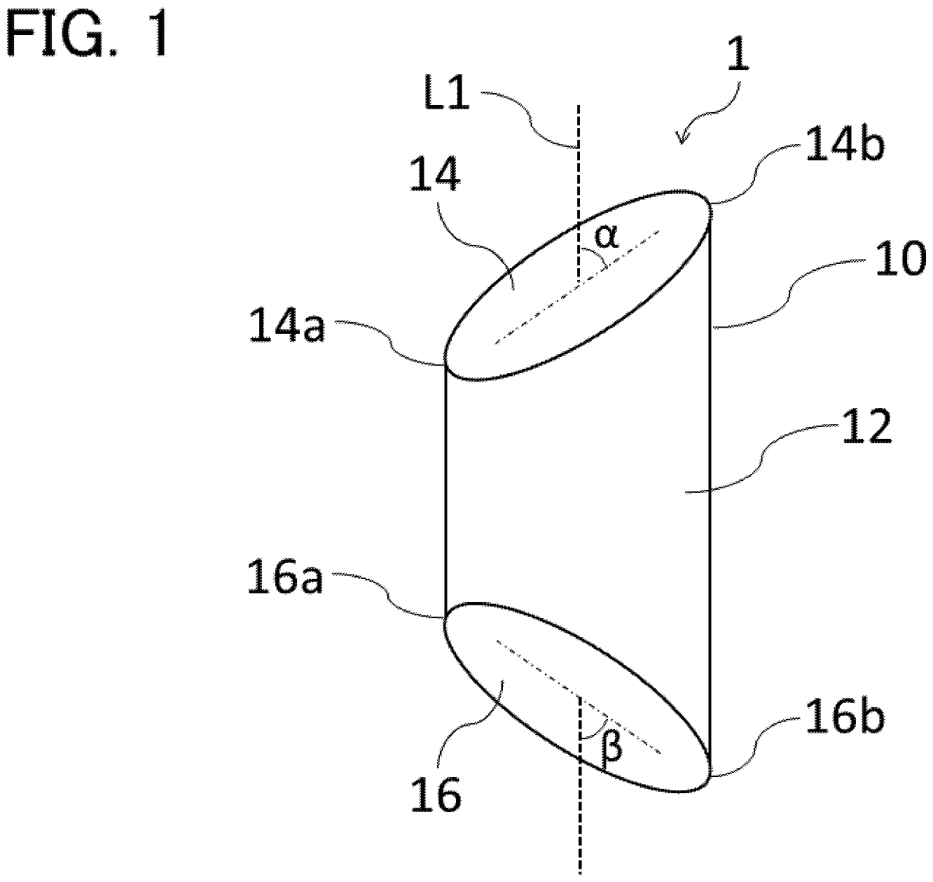

FIG. 1 is a perspective view showing an embodiment of a water absorption treatment material according to the present invention. A water absorption treatment material 1 is a water absorption treatment material that absorbs a liquid, and includes a grain 10. In the present embodiment, the water absorption treatment material 1 includes a plurality of the grains 10. However, only one of the grains 10 is shown in FIG. 1. The water absorption treatment material 1 is an excrement treatment material that absorbs excrement of animals or humans. The water absorption treatment material 1 is used, for example, in a state in which the plurality of grains 10 are placed in a box-shaped toilet.

The grain 10 has a water absorbing property, and absorbs the liquid. The particle diameter of each grain 10 is, for example, around 5 to 15 mm. As used herein, the particle diameter of the grain 10 is defined as the diameter of the minimum sphere that can include the grain 10.

The grain 10 is in an obliquely-cut columnar shape having a side surface 12, and a bottom surface 14 (first bottom surface) and a bottom surface 16 (second bottom surface). The side surface 12 is a curved surface corresponding to a part of the side surface of a column. The bottom surface 14 and the bottom surface 16 both obliquely intersect with the central axis L1 of the grain 10. The shape of each of the bottom surface 14 and the bottom surface 16 is an ellipse. The central axis L1 is an imaginary straight line that passes the center of the bottom surface 14 and the center of the bottom surface 16. The bottom surface 14 and the bottom surface 16 are apart from each other.

When the angle formed by the bottom surface 14 and the central axis L1 is denoted by α°, it is preferable that the α satisfies 20≤α≤70. Similarly, when the angle formed by the bottom surface 16 and the central axis L1 is denoted by ß°, it is preferable that the ß satisfies 20≤ß≤70. The α is equivalent to the angle formed by the plane including the bottom surface 14 and the central axis L1 (straight line), and is found according to the mathematical definition regarding the angle formed by a plane and a straight line. The same applies to the ß. The values of the α and the ß may be the same as each other, or may be different from each other.

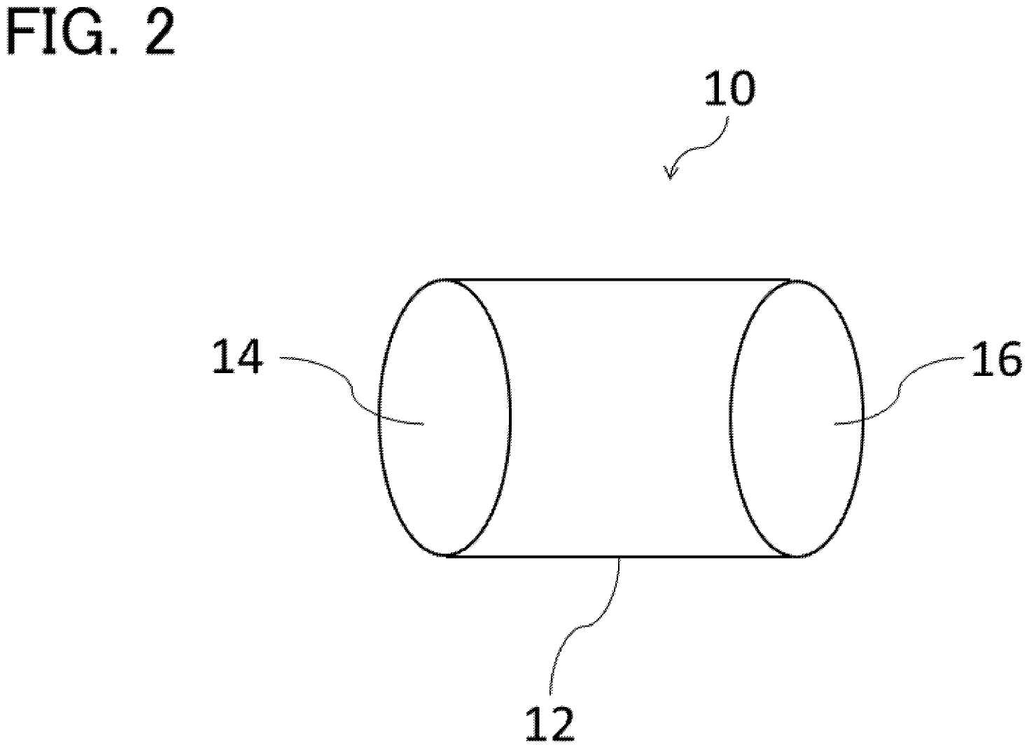

The bottom surface 14 and the bottom surface 16 are simultaneously visible from a same direction perpendicular to the central axis L1. In this case, it is sufficient that the bottom surface 14 and the bottom surface 16 are simultaneously visible when viewed from any direction perpendicular to the central axis L1. However, the entirety of each of the bottom surface 14 and the bottom surface 16 must be visible. For example, the bottom surface 14 and the bottom surface 16 are simultaneously visible as shown in FIG. 2 when viewed from the left direction in FIG. 1.

A nearest portion 14a of the bottom surface 14 and a nearest portion 16a of the bottom surface 16 exist on a same generating line of the side surface 12. That is, the line segment connecting the nearest portion 14a and the nearest portion 16a is parallel to the central axis L1. When a first plane is defined as the plane that passes the center of the bottom surface 14 and is perpendicular to the central axis L1, and a second plane is defined as the plane that passes the center of the bottom surface 16 and is perpendicular to the central axis L1, the nearest portion 14a is the portion of the bottom surface 14 that is nearest to the second plane. Also, the nearest portion 16a is the portion of the bottom surface 16 that is nearest to the first plane.

A farthest portion 14b of the bottom surface 14 and a farthest portion 16b of the bottom surface 16 also exist on a same generating line of the side surface 12. The farthest portion 14b is the portion of the bottom surface 14 that is farthest from the second plane. The farthest portion 16b is the portion of the bottom surface 16 that is farthest from the first plane. The generating line on which the nearest portions 14a, 16a exist (the line segment connecting the nearest portion 14a and the nearest portion 16a), and the generating line on which the farthest portions 14b, 16b exist (the line segment connecting the farthest portion 14b and the farthest portion 16b) are at directly opposite positions with the central axis L1 therebetween.

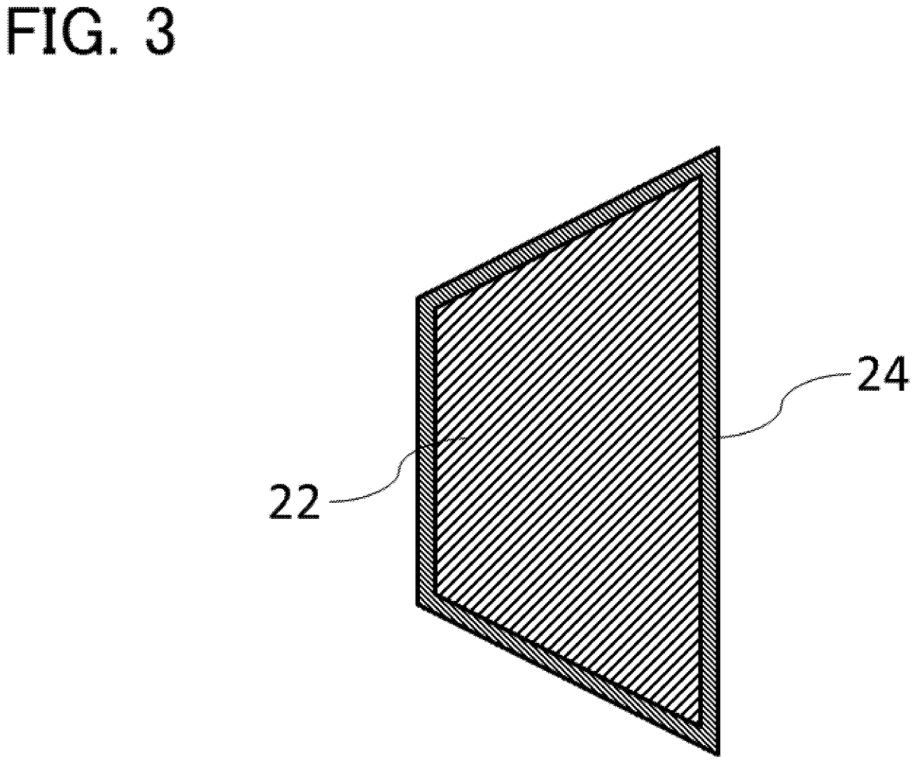

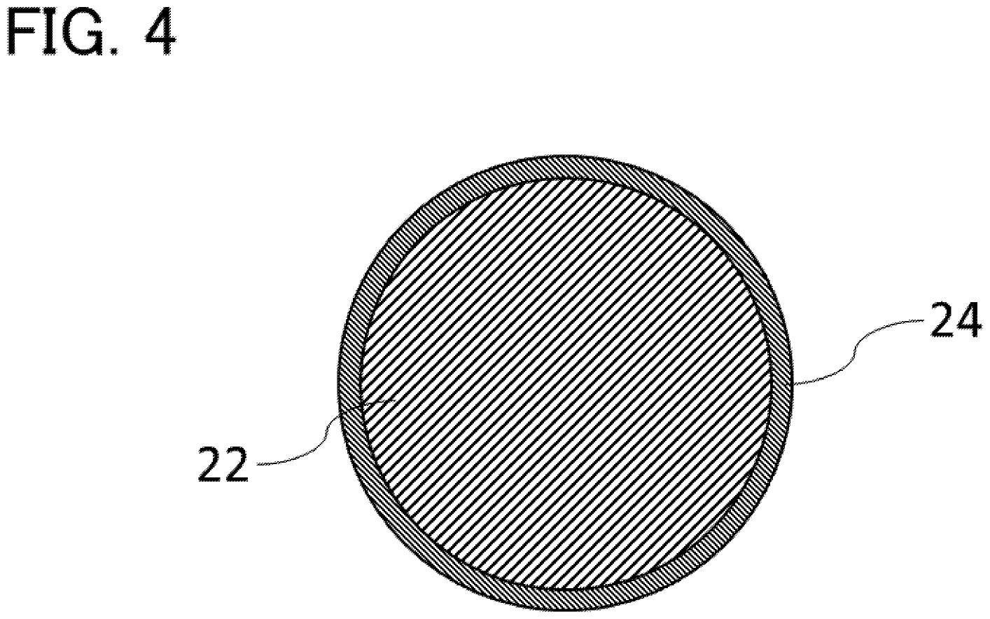

FIG. 3 and FIG. 4 are cross-sectional views of the grain 10. FIG. 3 shows the cross section where the grain 10 is cut by the plane including the generating line on which the nearest portions 14a, 16a exist and the central axis L1. FIG. 4 shows a cross section where the grain 10 is cut by a plane that exists between the bottom surface 14 and the bottom surface 16 and is perpendicular to the central axis L1.

The grain 10 has a core portion 22 and a coating portion 24. The core portion 22 is in a granular shape. Specifically, the core portion 22 is also in an obliquely-cut columnar shape similarly with the grain 10. The core portion 22 has a function of absorbing and retaining the liquid. The core portion 22 contains a water-absorbent material. The core portion 22 contains the water-absorbent material as its main material. As used herein, the main material of the core portion 22 refers to one of the material(s) constituting the core portion 22 that accounts for the highest weight ratio in the core portion 22. The core portion 22 may be composed only of the water-absorbent material, or may be composed of the water-absorbent material and another material. The water-absorbent material is preferably an organic substance. As the water-absorbent material that is an organic substance, papers, used tea leaves, plastics, or bean curd lees, for example, can be used.

The papers refer to a material composed mainly of pulp. Examples of the papers include, in addition to ordinary paper, a vinyl chloride wallpaper classified product (paper obtained by classifying vinyl chloride wallpaper), fluff pulp, papermaking sludge, and pulp sludge. As the plastics, a disposable diaper classified product (plastic obtained by classifying disposable diapers), for example, may be used. The bean curd lees are preferably dried bean curd lees.

The coating portion 24 covers the core portion 22. The coating portion 24 covers the entire surface of the core portion 22. The coating portion 24 has a function of bonding the grains 10 to clump them together when in use (when the water absorption treatment material 1 absorbs the liquid to be treated).

The coating portion 24 contains a water-absorbent material and an adhesive material. As the water-absorbent material contained in the coating portion 24, the papers, the used tea leaves, the plastics, or the bean curd lees, for example, can also be used. The coating portion 24 also contains the water-absorbent material as its main material. The definition of the main material of the coating portion 24 is the same as the definition of the main material of the core portion 22 described above. As the adhesive material, a water-absorbent polymer, starch, CMC (carboxymethyl cellulose), PVA (polyvinyl alcohol), or dextrin, for example, can be used.

Next, an example of a method for manufacturing the water absorption treatment material 1 will be described as an embodiment of a method for manufacturing a water absorption treatment material according to the present invention. This manufacturing method includes a grain forming step.

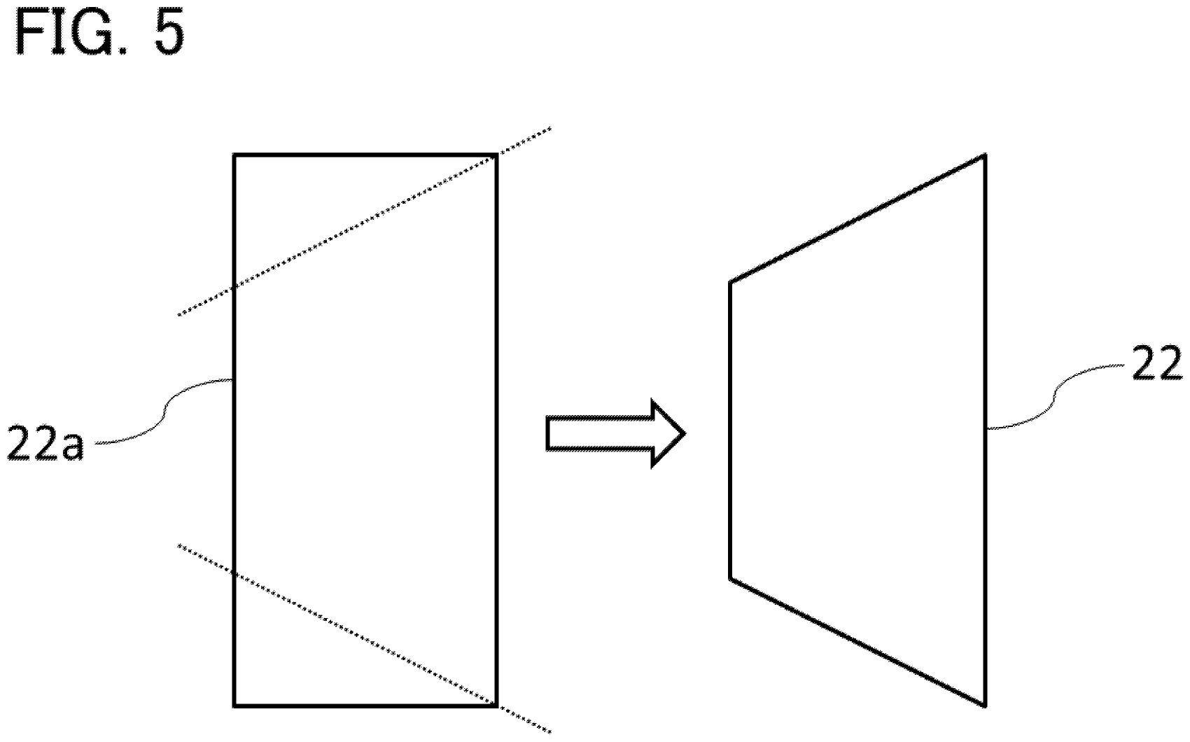

The grain forming step is a step of forming the grain 10. This step includes a core portion forming step and a coating portion forming step. The core portion forming step is a step of forming the core portion 22. In the core portion forming step, a granule that will serve as the core portion 22 is formed by granulating a core portion material (one or more materials constituting the core portion 22) with a granulation apparatus. Prior to the granulation, the core portion material is subjected to pre-treatment such as pulverization, kneading, and adding water, as needed. As the granulation apparatus, for example, an extrusion granulator can be used. For example, as shown in FIG. 5, the obliquely-cut columnar core portion 22 described above is obtained by obliquely cutting both ends of a columnar granule 22a (along the dotted lines in FIG. 5) after the granule 22a is formed. In the present embodiment, a plurality of the core portions 22 are formed.

The coating portion forming step is a step of forming the coating portion 24. In this step, the coating portion 24 is formed by attaching a powdery coating material (one or more materials constituting the coating portion 24) to the surface of the core portion 22 uniformly with a coating apparatus or the like. The coating material can be attached by, for example, sprinkling or spraying. After that, post-treatment such as sieving, and drying is performed as needed. Thus, the water absorption treatment material 1 consisting of the plurality of grains 10 is obtained.

Effects of the present embodiment will be described. In the present embodiment, the grain 10 is formed in the obliquely-cut columnar shape. The area of the bottom surfaces of the obliquely-cut column is larger than the area of the bottom surfaces of the original column. By enlarging the area of the bottom surfaces in this way, it is possible to increase the surface area of the grain 10 to improve water absorption velocity of the water absorption treatment material 1. Accordingly, the water absorption treatment material 1 that has excellent water absorption velocity, and the method for manufacturing the water absorption treatment material 1 are implemented.

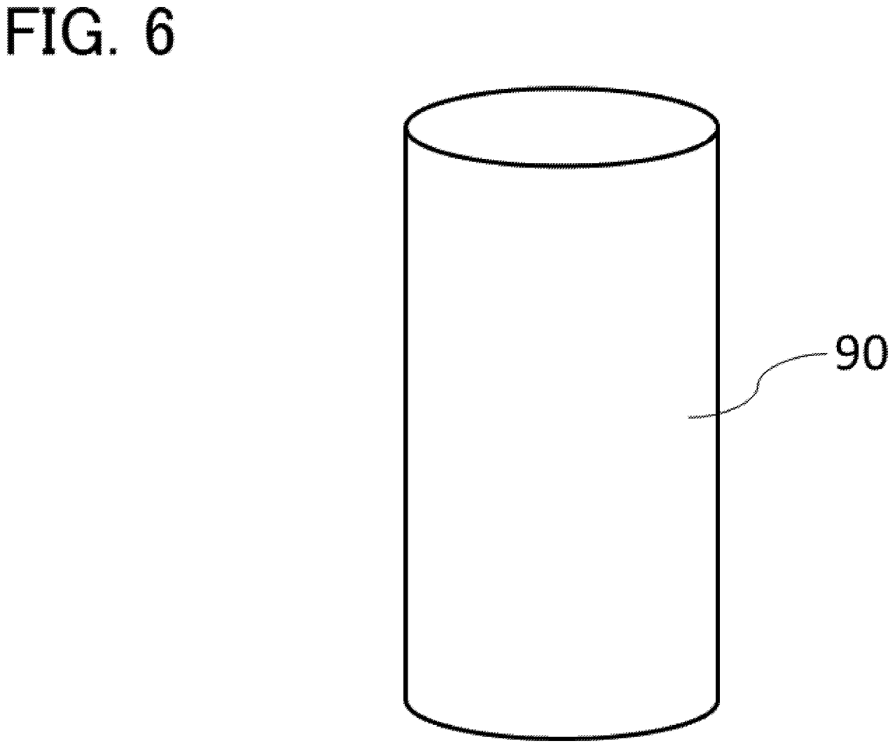

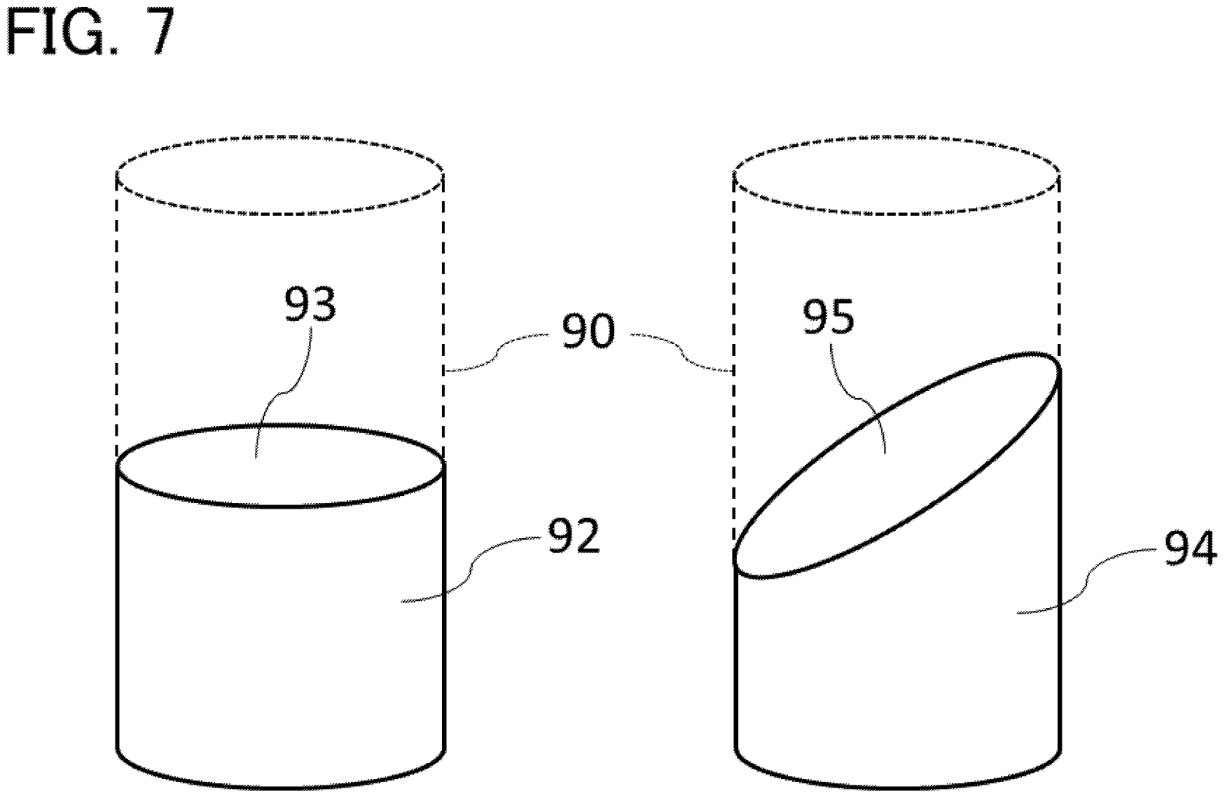

Referring to FIG. 6 to FIG. 8, the effect of increasing the surface area of an obliquely-cut column will be described in detail. Here, a column 92 obtained by cutting a column 90 shown in FIG. 6 by an orthogonally-intersecting plane (a plane that orthogonally intersects with the central axis of the column 90) to divide the column 90 into two equal parts, and an obliquely-cut column 94 obtained by cutting the column 90 by an obliquely-intersecting plane to divide the column 90 into two equal parts are considered (see FIG. 7). The column 92 and the obliquely-cut column 94 are both one of the two equal parts into which the column 90 is divided. Therefore, the side surface of the column 92 and the side surface of the obliquely-cut column 94 have the equal area (half of the area of the side surface of the column 90). Also, the column 92 and the obliquely-cut column 94 have the equal volume (half of the volume of the column 90).

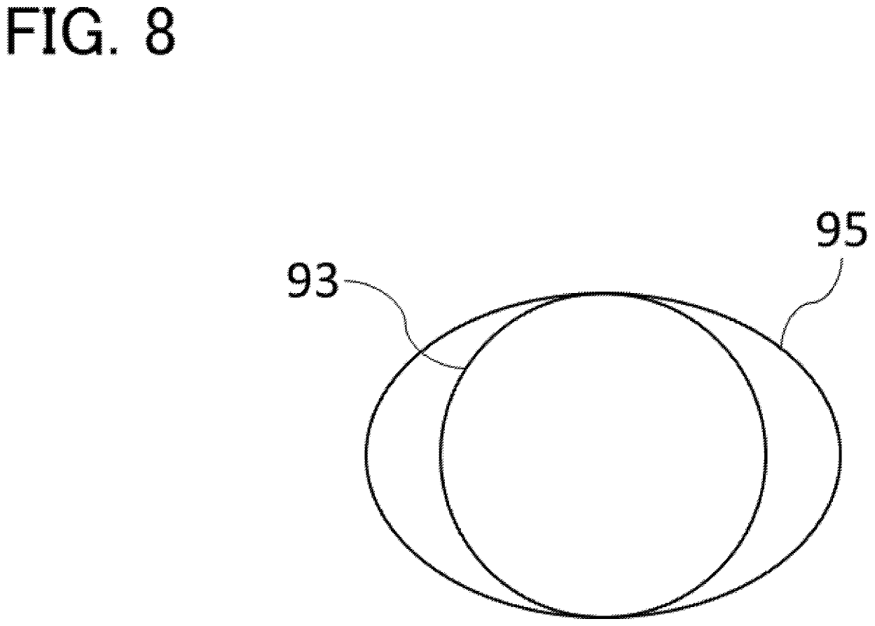

On the other hand, comparing a bottom surface 93 that is the cut surface of the column 92 with a bottom surface 95 that is the cut surface of the obliquely-cut column 94, the bottom surface 95 is elliptic while the bottom surface 93 is circular as shown in FIG. 8. FIG. 8 shows the bottom surface 93 and the bottom surface 95 superimposed on a same plane such that the centers thereof coincide with each other. Also, the short radius of the bottom surface 95 is equal to the radius of the bottom surface 93. Therefore, it is found that the bottom surface 95 includes the bottom surface 93, and the area of the bottom surface 95 is larger than the area of the bottom surface 93. In this way, it is possible to increase the surface area of a grain by making the grain an obliquely-cut column compared to a case where the grain is a column even though the volumes are equal.

The bottom surface 14 obliquely intersects with the central axis L1 of the grain 10. Thus, it is possible to increase the area of the bottom surface 14 compared to a case where the bottom surface 14 orthogonally intersects with the central axis L1.

The smaller the angle (α°) formed by the bottom surface 14 and the central axis L1 becomes, the larger the area of the bottom surface 14 becomes. From this viewpoint, the α preferably satisfies α≤70. If, on the other hand, the α is too small, an end portion (the end portion on the bottom surface 14 side) becomes thin, which may cause the grain 10 to be fragile. From this viewpoint, the α preferably satisfies 20≤α.

The bottom surface 16 obliquely intersects with the central axis L1 of the grain 10. Thus, it is possible to increase the area of the bottom surface 16 compared to a case where the bottom surface 16 orthogonally intersects with the central axis L1.

The smaller the angle (ß°) formed by the bottom surface 16 and the central axis L1 becomes, the larger the area of the bottom surface 16 becomes. From this viewpoint, the ß preferably satisfies ß≤70. If, on the other hand, the ß is too small, an end portion (the end portion on the bottom surface 16 side) becomes thin, which may cause the grain 10 to be fragile. From this viewpoint, the ß preferably satisfies 20≤ß.

The bottom surface 14 and the bottom surface 16 are simultaneously visible from a same direction perpendicular to the central axis L1. In this case, a deviation arises in the volume of the grain 10. Specifically, the volume on the side (visible side) from which the bottom surfaces 14, 16 are visible in the grain 10 is smaller than the volume on the side (invisible side) from which the bottom surfaces 14, 16 are not visible in the grain 10. In FIG. 1, the left side is the visible side, and the right side is the invisible side. For that reason, the centroid of the grain 10 shifts from the central axis L1 to the invisible side. Therefore, in the case where the grain 10 is laid on a floor such that the central axis L1 is horizontal, the grain 10 is stable in a state in which the invisible side faces downward, and is unlikely to roll on the floor. For this reason, it is possible to suppress the grains 10, which have spilled out of a toilet, scattering widely when the grains 10 are placed or used. Also, because the visible side of the grain 10 becomes more likely to face upward, there is also the advantage that a liquid (excrement) dropping from above becomes more likely to arrive at the bottom surface 14 and the bottom surface 16.

The nearest portion 14a of the bottom surface 14 and the nearest portion 16a of the bottom surface 16 exist on the same generating line of the side surface 12. In this case, the grain 10 is the most stable in the state in which the generating line faces directly upward. In this state, the areas of the bottom surface 14 and the bottom surface 16 in a plan view (the areas when viewed from directly above) become the maximum. Therefore, the state is optimum for the liquid dropping from above to arrive at the bottom surface 14 and the bottom surface 16.

The grain 10 has the core portion 22 and the coating portion 24. A clump of used grains 10 can be suitably obtained by providing the coating portion 24 on the core portion 22 in this way.

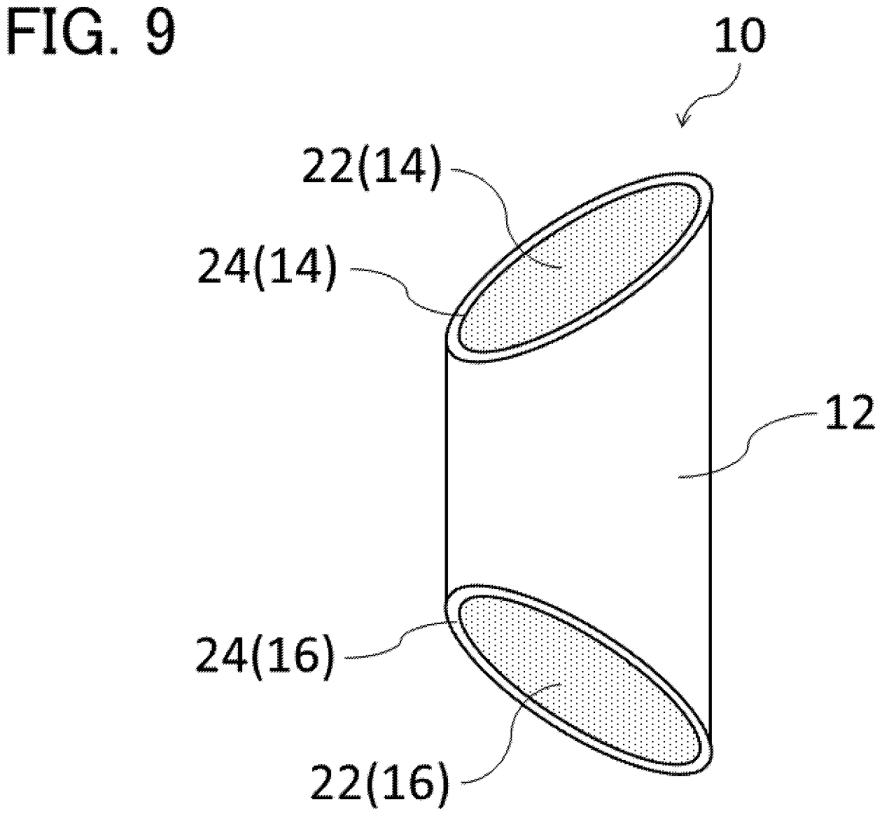

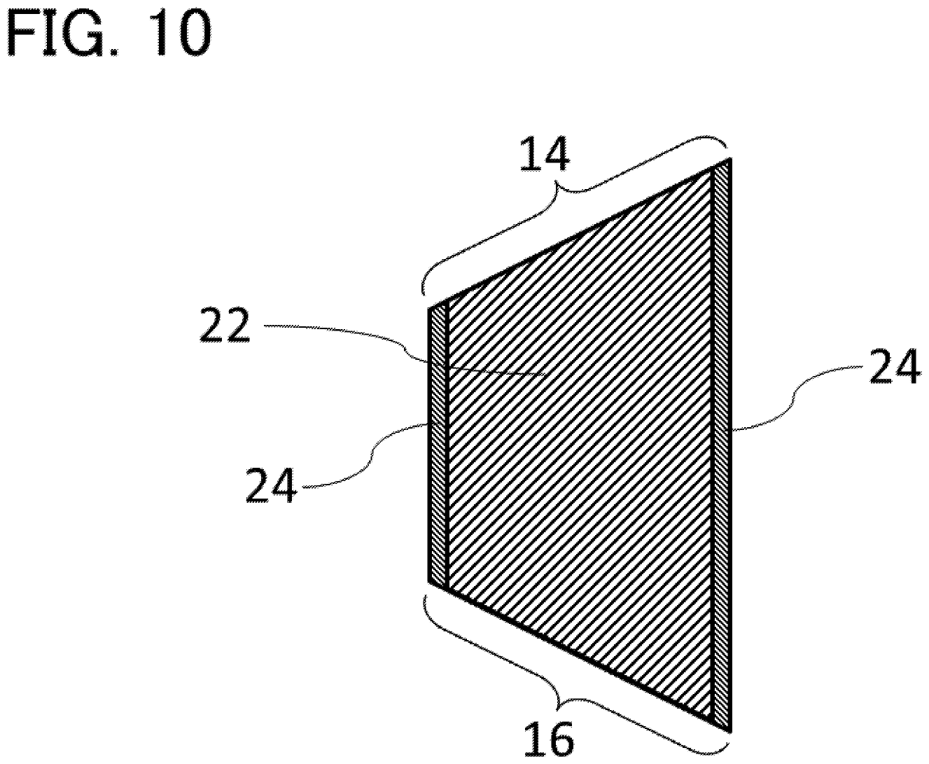

The present invention is not limited to the above-described embodiment, and various modifications can be made. In the above-described embodiment, an example is given in which the coating portion 24 covers the entire surface of the core portion 22. However, the coating portion 24 may cover only a part of the surface of the core portion 22 as shown, for example, in FIG. 9 and FIG. 10. In FIG. 9 and FIG. 10, the coating portion 24 is provided only on the side surface of the core portion 22, and is not provided on the bottom surfaces of the core portion 22. Therefore, the core portion 22 is exposed on the bottom surface 14 and the bottom surface 16 of the grain 10. The remaining parts (parts on which the coating portion 24 is not provided) of the surface of the core portion 22 can be exposed on the surface of the grain 10 by providing the coating portion 24 only on a part of the surface of the core portion 22 in this way. Thus, the liquid can speedily arrive at the core portion 22 through the exposed parts.

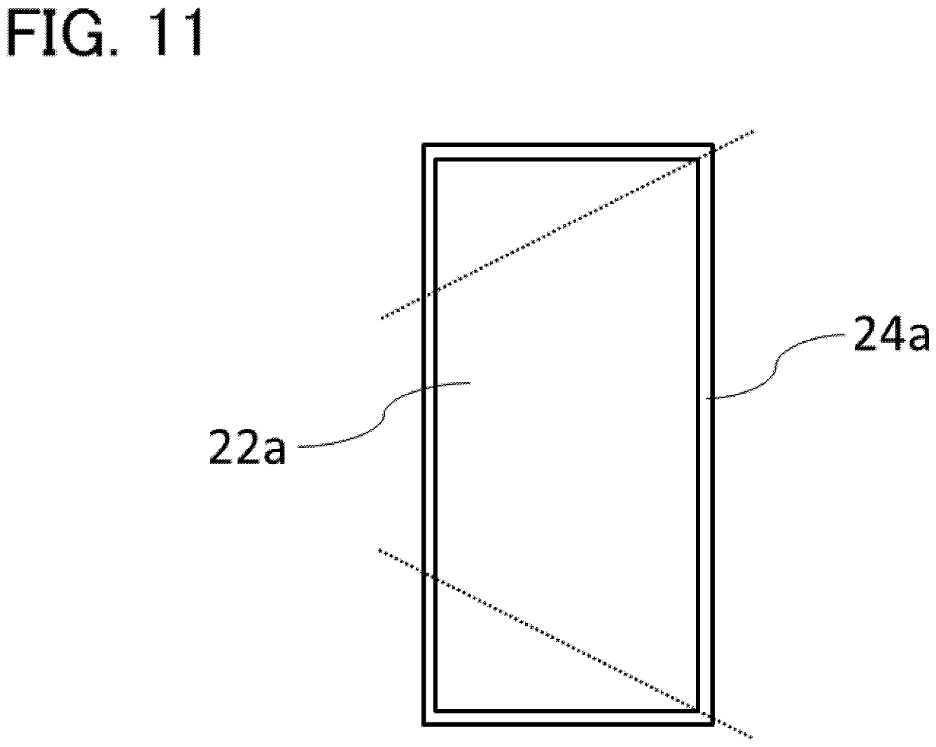

The grain 10 having such structure can be formed, for example, by attaching a coating material only to the side surface of the core portion 22 after the obliquely-cut columnar core portion 22 is formed. Otherwise, as shown in FIG. 11, the grain 10 having the above-described structure can be formed also by obliquely cutting the both ends of the granule 22a (along the dotted lines in FIG. 11) after a coating material 24a is attached to the entire surface of the columnar granule 22a. Although the core portion 22 is exposed on both of the bottom surface 14 and the bottom surface 16 in this example, it goes without saying that the core portion 22 may be exposed on only either one of the bottom surface 14 or the bottom surface 16.

In the above-described embodiment, an example is given in which both of the bottom surface 14 and the bottom surface 16 obliquely intersect with the central axis L1 of the grain 10. However, only either one of the bottom surface 14 or the bottom surface 16 may obliquely intersect with the central axis L1. That is, one bottom surface may obliquely intersect with the central axis L1 with the other bottom surface orthogonally intersecting with the central axis L1.

In the above-described embodiment, an example is given in which the grain 10 has a multi-layer structure (double-layer structure) composed of the core portion 22 and the coating portion 24. However, it is not essential to provide the coating portion 24. That is, the grain 10 may have a single-layer structure composed only of the core portion 22.

In the above-described embodiment, an example is given in which the water absorption treatment material is an excrement treatment material. However, the water absorption treatment material may be a vomit treatment material that absorbs vomit, or may be a kitchen garbage treatment material that absorbs kitchen garbage (moisture contained in the kitchen garbage).

### LIST OF REFERENCE NUMERALS

1 Water Absorption Treatment Material
10 Grain
12 Side Surface
14 Bottom Surface (First Bottom Surface)
14a Nearest Portion
14b Farthest Portion
16 Bottom Surface (Second Bottom Surface)
16a Nearest Portion
16b Farthest Portion
22 Core Portion
22a Granule
24 Coating Portion
24a Coating Material
90 Column
92 Column
93 Bottom Surface
94 Obliquely-Cut Column
95 Bottom Surface
L1 Central Axis

1. A water absorption treatment material that absorbs a liquid comprising:
a grain that has a water absorbing property,
wherein the grain is in an obliquely-cut columnar shape having a side surface, and first and second bottom surfaces.

2. The water absorption treatment material according to claim 1,
wherein the first bottom surface obliquely intersects with a central axis of the grain.

3. The water absorption treatment material according to claim 2,
wherein when an angle formed by the first bottom surface and the central axis is denoted by α°, the α satisfies 20≤α≤70.

4. The water absorption treatment material according to claim 2,
wherein the second bottom surface obliquely intersects with the central axis.

5. The water absorption treatment material according to claim 4,
wherein when an angle formed by the second bottom surface and the central axis is denoted by ß°, the ß satisfies 20≤ß≤70.

6. The water absorption treatment material according to claim 4,
wherein the first and second bottom surfaces are simultaneously visible from a same direction perpendicular to the central axis.

7. The water absorption treatment material according to claim 6,
wherein when a first plane is defined as a plane that passes a center of the first bottom surface and is perpendicular to the central axis, and a second plane is defined as a plane that passes a center of the second bottom surface and is perpendicular to the central axis,
a portion of the first bottom surface that is nearest to the second plane, and a portion of the second bottom surface that is nearest to the first plane exist on a same generating line of the side surface.

8. The water absorption treatment material according to claim 1,
wherein the grain has a granular core portion, and a coating portion that covers a surface of the core portion.

9. The water absorption treatment material according to claim 8,
wherein the coating portion covers only a part of the surface of the core portion.

10. The water absorption treatment material according to claim 9,
wherein the core portion is exposed on the first bottom surface and/or the second bottom surface of the grain.

11. A method for manufacturing a water absorption treatment material that absorbs a liquid, the method comprising:
a grain forming step of forming a grain that has a water absorbing property,
wherein in the grain forming step, the grain that is in an obliquely-cut columnar shape having a side surface, and first and second bottom surfaces is formed.

12. The method for manufacturing a water absorption treatment material according to claim 11,
wherein in the grain forming step, the grain is formed such that the first bottom surface obliquely intersects with a central axis of the grain.

13. The method for manufacturing a water absorption treatment material according to claim 12,
wherein when an angle formed by the first bottom surface and the central axis is denoted by α°, the α satisfies 20≤α≤70.

14. The method for manufacturing a water absorption treatment material according to claim 12,
wherein in the grain forming step, the grain is formed such that the second bottom surface obliquely intersects with the central axis.

15. The method for manufacturing a water absorption treatment material according to claim 14,
wherein when an angle formed by the second bottom surface and the central axis is denoted by ß°, the ß satisfies 20≤ß≤70.

16. The method for manufacturing a water absorption treatment material according to claim 14,
wherein in the grain forming step, the grain is formed such that the first and second bottom surfaces are simultaneously visible from a same direction perpendicular to the central axis.

17. The method for manufacturing a water absorption treatment material according to claim 16,
wherein when a first plane is defined as a plane that passes a center of the first bottom surface and is perpendicular to the central axis, and a second plane is defined as a plane that passes a center of the second bottom surface and is perpendicular to the central axis,
in the grain forming step, the grain is formed such that a portion of the first bottom surface that is nearest to the second plane, and a portion of the second bottom surface that is nearest to the first plane exist on a same generating line of the side surface.

18. The method for manufacturing a water absorption treatment material according to claim 11,
wherein the grain forming step includes a core portion forming step of forming a granular core portion, and a coating portion forming step of forming a coating portion that covers a surface of the core portion.

19. The method for manufacturing a water absorption treatment material according to claim 18,
wherein in the coating portion forming step, the coating portion is formed so as to cover only a part of the surface of the core portion.

20. The method for manufacturing a water absorption treatment material according to claim 19,
wherein in the coating portion forming step, the coating portion is formed such that the core portion is exposed on the first bottom surface and/or the second bottom surface of the grain.
